(19) United States
(12) Patent Application Publication
(10) Pub. No.: US 2026/0175793 A1
(43) Pub. Date: Jun. 25, 2026

(54) WINDOW GLASS WITH BRACKET FOR VEHICLE

(71) Applicant: AGC Inc., Tokyo (JP)

(72) Inventors: Naonori HATTA, Tokyo (JP); Ryoichi URATA, Tokyo (JP); Takafumi INOUE, Tokyo (JP); Yoshiyuki ASUWA, Tokyo (JP); Takashi KAWAHARA, Tokyo (JP); Satoshi KANEKO, Tokyo (JP)

(73) Assignee: AGC Inc., Tokyo (JP)

(21) Appl. No.: 19/541,297

(22) Filed: Feb. 16, 2026

Related U.S. Application Data
(63) Continuation of application No. PCT/JP2024/030977, filed on Aug. 29, 2024.

(30) Foreign Application Priority Data
Sep. 5, 2023 (JP) 2023-143622

(51) Int. Cl. B60R 11/04; B60R 11/00

(52) U.S. Cl. CPC B60R 11/04; B60R 2011/0026; B60R 2011/0064

(57) ABSTRACT

A window glass with a bracket for vehicle in which the manufacturing cost of the bracket can be reduced is provided. A window glass with a bracket for vehicle according to an aspect of the present disclosure includes a window glass for vehicle and a bracket made of a resin for fixing an information acquisition apparatus to the window glass for vehicle. The bracket includes a plurality of bracket pieces. The plurality of bracket pieces are each disposed so as to be spaced apart from each other on a main surface of the window glass for vehicle.

### INCORPORATION BY REFERENCE

This application is based upon and claims the benefit of priority from Japanese patent application No. 2023-143622 filed on Sep. 5, 2023, and PCT application No. PCT/JP 2024/030977 filed on Aug. 29, 2024, the disclosure of which is incorporated herein in its entirety by reference.

### BACKGROUND

The present disclosure relates to a window glass with a bracket for vehicle.

In recent years, an advanced driver assistance system (ADAS) in which an information acquisition apparatus such as a camera is attached to a vehicle has been developed. The information acquisition apparatus used in the advanced driver assistance system is fixed to a windshield through a bracket made of a resin. For example, the bracket made of a resin is bonded to the windshield using an adhesive member, and the information acquisition apparatus is fixed to the bonded bracket. The information acquisition apparatus includes a main body and a cover which covers the main body, and after the main body is fixed to the bracket bonded to the windshield, the cover which covers the main body is fixed to the bracket.

Patent Literature 1 and Patent Literature 2 each disclose a technique related to a bracket for fixing an information acquisition apparatus such as a camera to a window glass for vehicle.

Patent Literature 1: Japanese Unexamined Patent Application Publication No. 2021-91339

Patent Literature 2: International Patent Publication No. WO

### SUMMARY

Since such a bracket is designed for each vehicle type, the number of types of brackets increases as the number of types of vehicles increases. Thus, the number of types of dies required to manufacture the bracket increases, so that there is a problem that the manufacturing cost of the bracket increases.

In view of the above-described problem, an object of the present disclosure is to provide a window glass with a bracket for vehicle in which the manufacturing cost of the bracket can be reduced.

A window glass with a bracket for vehicle according to an aspect of the present disclosure comprises:
a window glass for vehicle; and
a bracket made of a resin for fixing an information acquisition apparatus to the window glass for vehicle, the bracket comprising a plurality of bracket pieces,
wherein the plurality of bracket pieces are each disposed so as to be spaced apart from each other on a main surface of the window glass for vehicle.

By the window glass with a bracket for vehicle according to an aspect of the present disclosure, it is possible to reduce the manufacturing cost of the bracket.

The above and other objects, features and advantages of the present disclosure will become more fully understood from the detailed description given hereinbelow and the accompanying drawings.

### BRIEF DESCRIPTION OF DRAWINGS

FIG. 1 is a perspective view for explaining an example of a configuration of a bracket according to an embodiment;

FIG. 2 is a plan view for explaining the example of the configuration of the bracket according to the embodiment;

FIG. 3 is a perspective view for explaining a state in which a cover is fixed to the bracket shown in FIG. 2;

FIG. 4 is a plan view for explaining another example of a configuration of a bracket according to the embodiment;

FIG. 5 is a perspective view for explaining a state in which a cover is fixed to the bracket shown in FIG. 4;

FIG. 6 is a perspective view for explaining a bracket according to related art;

FIG. 7 is a cross-sectional view for explaining a state in which the bracket according to the embodiment is attached to a window glass for vehicle;

FIG. 8 is a cross-sectional view for explaining a state in which the bracket according to the embodiment is attached to the window glass for vehicle;

FIG. 9 is a plan view for explaining an example of a configuration of a window glass for vehicle to which the bracket according to the embodiment is attached;

FIG. 10 is a plan view for explaining a method for positioning the bracket according to the embodiment in the window glass for vehicle;

FIG. 11 is a plan view for explaining a method for attaching the bracket according to the embodiment to the window glass for vehicle; and

FIG. 12 is a plan view for explaining the method for attaching the bracket according to the embodiment to the window glass for vehicle.

### DESCRIPTION OF EMBODIMENTS

Embodiments will be described hereinafter with reference to the drawings.

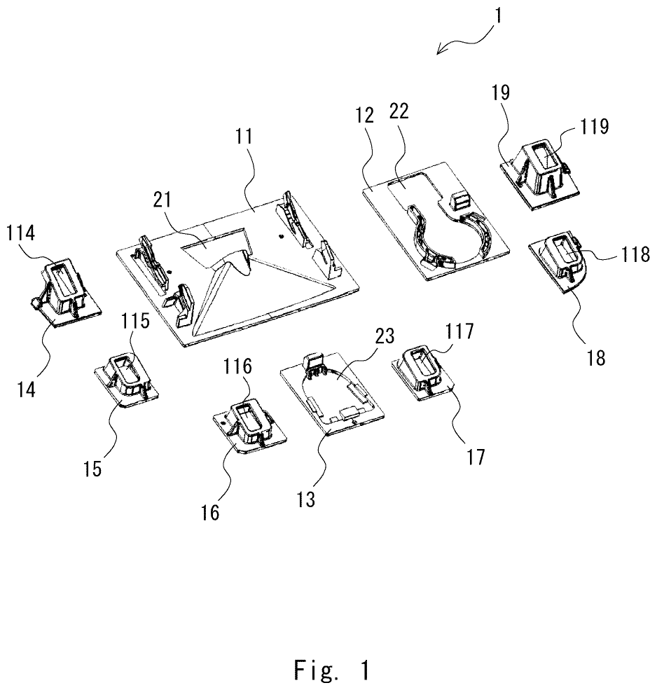

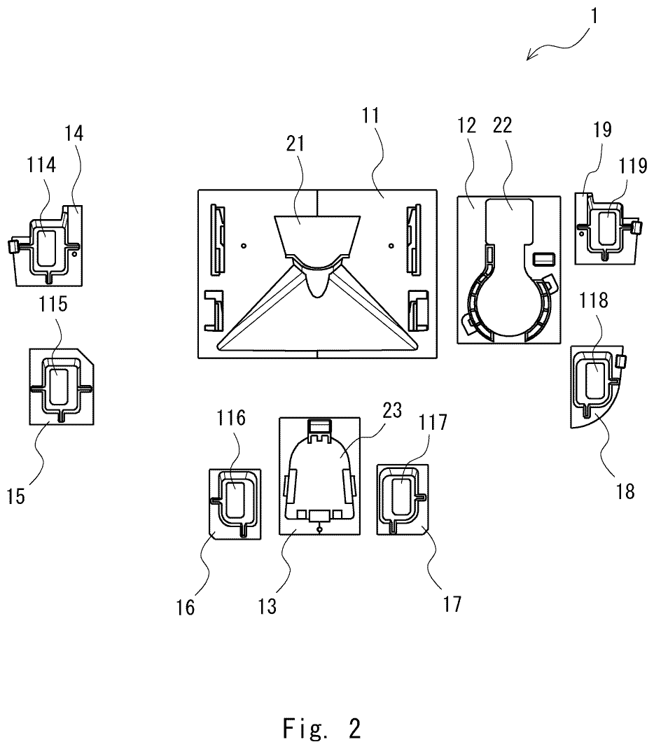

FIG. 1 is a perspective view for explaining a bracket according to an embodiment. FIG. 2 is a plan view for explaining the bracket according to the embodiment. As shown in FIGS. 1 and 2, a bracket 1 according to this embodiment is a bracket made of a resin for fixing an information acquisition apparatus to a window glass for vehicle, and includes a plurality of bracket pieces 11 to 19. The plurality of bracket pieces 11 to 19 are each disposed so as to be spaced apart from each other on a main surface of the window glass for vehicle. Each of the bracket pieces 11 to 19 is bonded to the window glass for vehicle by using an adhesive member. The information acquisition apparatus includes a main body having a function of acquiring information, and a cover which covers the main body.

The bracket 1 includes the apparatus fixing bracket pieces 11, 12, and 13 for fixing the main body of the information acquisition apparatus, and the cover fixing bracket pieces 14 to 19 for fixing the cover which covers the main body of the information acquisition apparatus. Note that, in this specification, the apparatus fixing bracket pieces 11, 12, and 13 and the cover fixing bracket pieces 14 to 19 are also referred to as the bracket pieces 11 to 19.

The apparatus fixing bracket pieces 11, 12, and 13 are bracket pieces for fixing the main body (not shown) of the information acquisition apparatus. Note that the information acquisition apparatus is, for example, at least one of a camera, a millimeter-wave radar, an infrared sensor, a communication device, a raindrop sensor, a temperature and humidity sensor, and a mirror base for a rearview mirror. Note that the information acquisition apparatus according to this embodiment is not limited thereto, and it may be any apparatus which can be mounted on the window glass for vehicle.

The apparatus fixing bracket pieces 11, 12, and 13 include hole parts 21, 22, and 23, respectively. In this embodiment, information about the outside of a vehicle can be appropriately acquired, for example, by aligning the lens of the camera, the light receiving unit of the raindrop sensor, and the mirror base with the positions of the hole parts 21, 22, and 23.

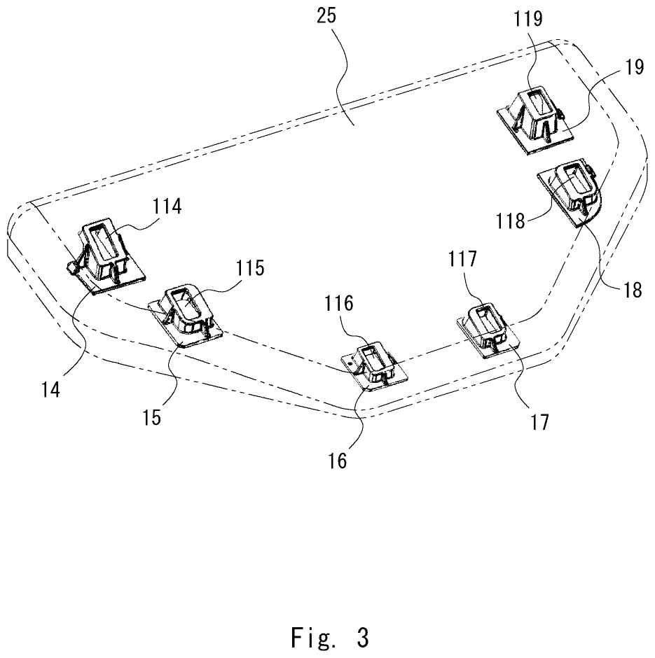

The cover fixing bracket pieces 14 to 19 are bracket pieces for fixing a cover which covers the information acquisition apparatus. Fixing parts 114 to 119 for fixing the cover are respectively formed in the cover fixing bracket pieces 14 to 19. Further, the cover fixing bracket pieces 14 to 19 are disposed around the apparatus fixing bracket pieces 11 to 13 on the main surface of the window glass for vehicle. Therefore, as shown in FIG. 3, a cover 25 is disposed on the cover fixing bracket pieces 14 to 19 so as to cover the information acquisition apparatus. The number of the cover fixing bracket pieces to be disposed is preferably one to ten, more preferably two to eight, and still more preferably three to six.

The cover 25 can be fixed by engaging projections (not shown) provided in the cover 25 with the fixing parts 114 to 119. Further, the cover 25 may be fixed by screwing the cover 25 to the cover fixing bracket pieces 14 to 19. Note that, in FIG. 3, illustration of the apparatus fixing bracket pieces 11 to 13 is omitted.

Each of the plurality of bracket pieces 11 to 19 according to this embodiment can be made of a resin material. Polybutylene terephthalate (PBT), a mixed material of polycarbonate (PC) and acrylonitrile butadiene styrene (ABS), or the like is used as the resin material. Further, these resins may be mixed with glass fibers. Each of the bracket pieces 11 to 19 can be formed by using injection molding. That is, each of the bracket pieces 11 to 19 can be formed by injecting a molten resin material into a mold corresponding to the shape of each of the bracket piece 11 to 19 and then cooling it.

Each of the apparatus fixing bracket pieces 11, 12, and 13 according to this embodiment may be formed of a material having a rigidity higher than that of each of the cover fixing bracket pieces 14 to 19. For example, each of the apparatus fixing bracket pieces 11, 12, and 13 may be formed of a resin containing a glass fiber. Since a heavy information acquisition apparatus (main body) is attached to the apparatus fixing bracket pieces 11, 12, and 13, a larger load is applied to them than to the cover fixing bracket pieces 14 to 19. Therefore, each of the apparatus fixing bracket pieces 11, 12, and 13 is preferably formed of a material having a high rigidity.

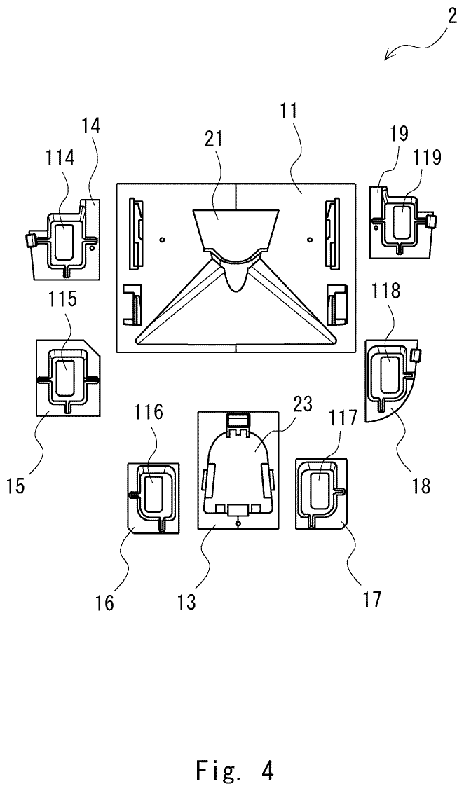

FIG. 4 is a plan view for explaining another example of a configuration of a bracket according to this embodiment. A bracket 2 shown in FIG. 4 is formed by using the bracket pieces 11 and 13 to 19 of the bracket pieces 11 to 19 of the bracket 1 shown in FIG. 2. That is, in the bracket 2 shown in FIG. 4, the apparatus fixing bracket piece 12 of the bracket 1 shown in FIG. 2 is omitted.

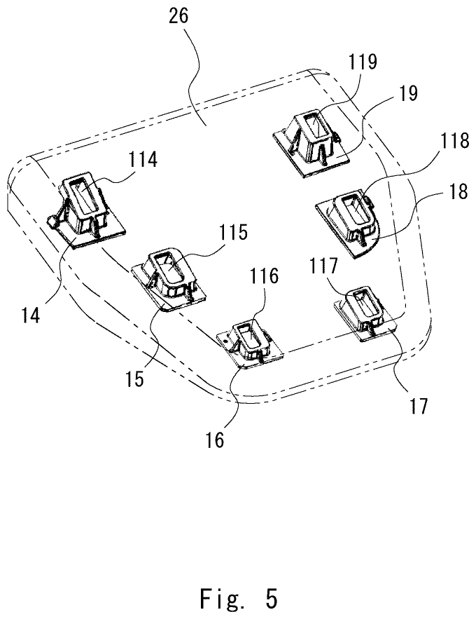

FIG. 5 is a perspective view for explaining a state in which a cover 26 is fixed to the bracket 2 shown in FIG. 4. As shown in FIG. 5, the cover 26 can be fixed by engaging projections (not shown) provided in the cover 26 with the fixing parts 114 to 119 respectively formed in the cover fixing bracket pieces 14 to 19. The bracket 2 shown in FIG. 4 is smaller than the bracket 1 shown in FIG. 2.

Therefore, as shown in FIGS. 3 and 5, the cover 26 fixed to the bracket 2 is smaller than the cover 25 fixed to the bracket 1.

As described above, in this embodiment, the brackets 1 and 2 are formed by using the plurality of bracket pieces 11 to 19, and the plurality of bracket pieces 11 to 19 are each disposed so as to be spaced apart from each other on the main surface of the window glass for vehicle. In this embodiment, since the brackets 1 and 2 are formed by the plurality of bracket pieces 11 to 19, various types of brackets can be formed by changing the number and the positions of the bracket pieces 11 to 19 to be used (see FIGS. 2 and 4). Therefore, the manufacturing cost of the bracket for attaching the information acquisition apparatus to the window glass for vehicle can be reduced.

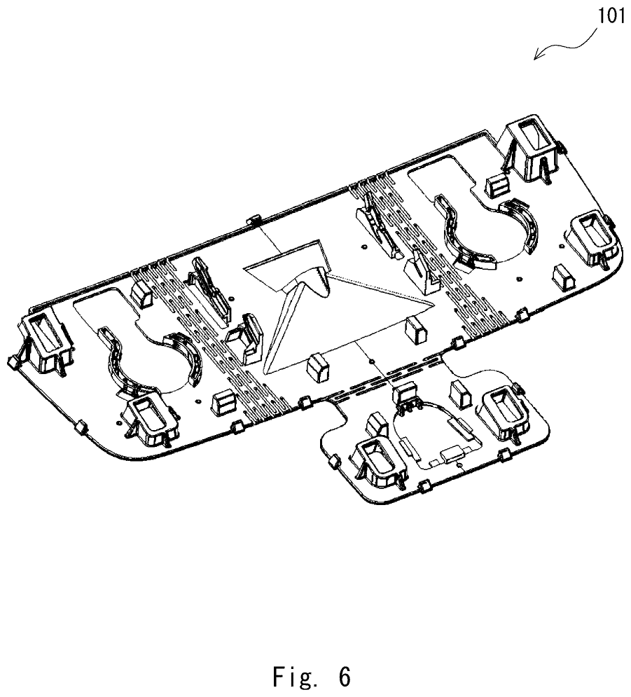

FIG. 6 is a perspective view for explaining a bracket according to related art. As shown in FIG. 6, a bracket 101 according to the related art is integrally formed by using a resin material. Therefore, when the type of the information acquisition apparatus to be mounted is changed, it is required to newly design a bracket in accordance with the change. Further, since such a bracket is designed for each vehicle type, the number of types of brackets increases as the number of types of vehicles increases. Thus, as the number of types of brackets increases, the number of types of dies required to manufacture the bracket increases, so that there is a problem that the manufacturing cost of the bracket increases.

In contrast, in this embodiment, the brackets 1 and 2 are formed by using the plurality of bracket pieces 11 to 19. Therefore, various types of brackets can be formed by changing the number and the positions of the bracket pieces 11 to 19 to be used. For example, in the bracket 1 shown in FIG. 2, when the information acquisition apparatus mounted on the bracket piece 12 is no longer needed, the bracket 2 can be formed by changing the positions of the bracket pieces 11 and 13 to 19 excluding the bracket piece 12 as shown in FIG. 4. That is, various kinds of brackets can be formed by using the bracket pieces 11 to 19 that are common components. Namely, bracket pieces to be used can be selected from among the bracket pieces 11 to 19 as appropriate and combined. When bracket pieces to be used are selected from among the bracket pieces 11 to 19 as appropriate and combined, it is preferable to select one or more apparatus fixing bracket pieces and one or more cover fixing bracket pieces. Therefore, the number of kinds of parts of the bracket for attaching the information acquisition apparatus to the window glass for vehicle can be reduced, and hence the manufacturing cost of the bracket can be reduced.

Further, in recent years, the number of information acquisition apparatuses attached to a window glass for vehicle has increased with the enhancement of the function of the advanced driver assistance system. As the number of information acquisition apparatuses increases as mentioned above, the area of the bracket to which the information acquisition apparatus is attached increases. Conventionally, as the area of the bracket increases, a restoring force (a force that acts to bring the bracket to its original state) acting on the bracket bonded to the window glass for vehicle having a curved shape increases. Therefore, there is a problem that after a bracket is bonded to the window glass for vehicle, the bracket falls off or is warped.

In contrast, in this embodiment, the brackets 1 and 2 are formed by using the plurality of bracket pieces 11 to 19. Thus, even if the area of the bracket is increased, the contact area of the brackets 1 and 2 with the window glass for vehicle through adhesive members is smaller than that of the integrally-formed bracket according to the related art. Therefore, it is possible to prevent a restoring force from acting on the bracket bonded to the window glass for vehicle having a curved shape. By this configuration, it is possible to prevent the bracket from falling off or being warped after it is bonded to the window glass for vehicle.

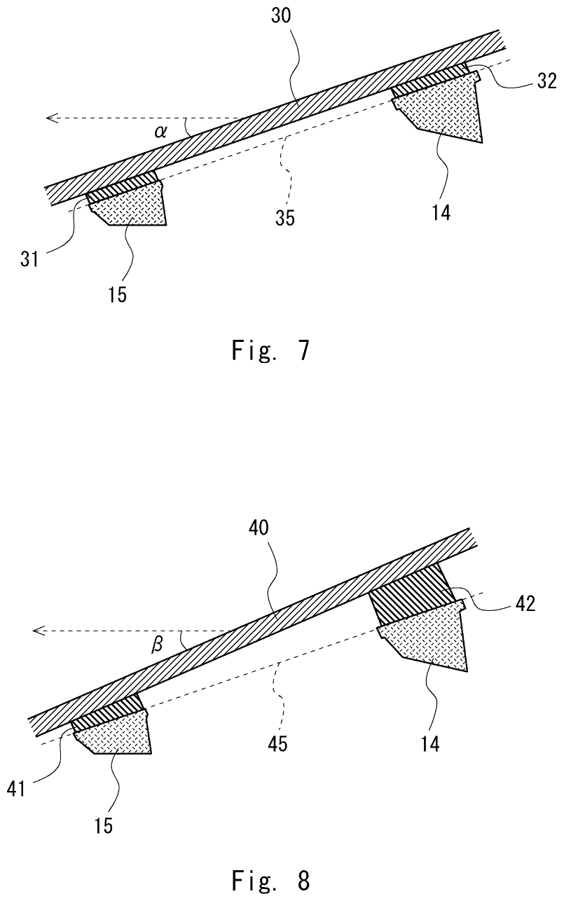

Each of FIGS. 7 and 8 is a cross-sectional view for explaining a state in which the bracket according to this embodiment is attached to the window glass for vehicle. FIGS. 7 and 8 show examples of configurations in which window glasses for vehicle 30 and 40 have different angles a and B with respect to the horizontal plane. Specifically, the angle a with respect to the horizontal plane of the window glass for vehicle 30 shown in FIG. 7 is smaller than the angle B with respect to the horizontal plane of the window glass for vehicle 40 shown in FIG. 8. Note that FIGS. 7 and 8 illustrate states in which the bracket pieces 14 and 15 are attached to the window glasses for vehicle 30 and 40 as examples, and the same is true when other bracket pieces are attached.

As shown in FIG. 7, the respective bracket pieces 14 and 15 are bonded to the window glass for vehicle 30 by using adhesive members 31 and 32. Adhesives, double-sided tapes, or the like can be used for the adhesive members 31 and 32. In the example of the configuration shown in FIG. 7, a straight line 35 connecting the bonding surfaces of the bracket pieces 14 and 15 to each other is substantially parallel to the main surface of the window glass for vehicle 30.

Similarly, in the example of the configuration shown in FIG. 8, the respective bracket pieces 14 and 15 are bonded to the window glass for vehicle 40 by using adhesive members 41 and 42. Adhesives, double-sided tapes, or the like can be used for the adhesive members 41 and 42. In the example of the configuration shown in FIG. 8, a straight line 45 connecting the bonding surfaces of the bracket pieces 14 and 15 to each other is not parallel to the main surface of the window glass for vehicle 40. In this embodiment, by adjusting the thicknesses of the adhesive members 41 and 42 provided between the respective bracket pieces 14 and 15 and the window glass for vehicle 40, an angle at which each of the bracket pieces is attached to the main surface of the window glass for vehicle 40, that is, an angle of the straight line 45 connecting the bonding surfaces of the bracket pieces 14 and 15 to each other is adjusted. For example, a double-sided tape having a predetermined thickness may be used as each of the adhesive members 41 and 42. By using the double-sided tape, the thicknesses of the adhesive members 41 and 42 can be easily adjusted. Since the angle at which each of the bracket pieces 14 and 15 is attached can be adjusted by adjusting the thicknesses of the adhesive members 41 and 42 in this way, a plurality of bracket pieces can be attached to various kinds of window glasses for vehicle. Note that the angle at which each of the bracket pieces is attached to the main surface of the window glass for vehicle 40 is β-α.

In the window glass with a bracket for vehicle according to this embodiment, the thicknesses of the adhesive members 41 and 42 provided between the respective bracket pieces 14 and 15 and the window glass for vehicle 40 are different from each other, and the angle at which each of the bracket pieces is attached to the main surface of the window glass for vehicle 40 is greater than 0°and smaller than or equal to 15°. Since the angle at which the bracket piece is attached is in the above range, the bonding strength between the bracket piece and the window glass for vehicle can be maintained high while the number of kinds of brackets is prevented from increasing.

Each of the window glasses for vehicle 30 and 40 according to this embodiment may be one glass plate or a laminated glass. When the window glass for vehicle is a windshield, the window glass for vehicle is preferably a laminated glass. The laminated glass is formed by bonding an interior side glass plate positioned on the interior side of the vehicle to an exterior side glass plate positioned on the exterior side of the vehicle through an intermediate film when it is attached to the vehicle. The window glass for vehicle according to this embodiment is not limited to a windshield, and may instead be a window glass for vehicle such as rear glass, a side glass, or a roof glass, or a window glass for vehicle used in a train etc., or the like.

The window glass for vehicle may be an inorganic glass or an organic glass. As the inorganic glass, for example, a soda lime glass, an aluminosilicate glass, a borosilicate glass, an alkaline-free glass, a quartz glass, or the like is used. Among these glasses, a soda lime glass is particularly preferable in view of the manufacturing cost and the formability. The method for forming the window glass for vehicle is not limited to a particular method. For example, in the case of the inorganic glass, it is preferably formed using a float method or the like.

When the window glass for vehicle is an inorganic glass, the window glass for vehicle may be either an untempered glass or a tempered glass. The untempered glass is obtained by molding molten glass into a plate shape and slowly cooling it. The tempered glass is obtained by forming a compressive stress layer on the surface of an untempered glass, and may be either an air-cooled tempered glass or a chemically tempered glass. Note that when the window glass for vehicle is a laminated glass, the glass plate on the interior side of the vehicle and the glass plate on the exterior side of the vehicle may be untempered glasses. When the window glass for vehicle is formed of one glass plate, it may be a tempered glass. Further, as the window glass for vehicle, a glass that absorbs ultraviolet rays or infrared rays may be used. Although the window glass for vehicle is preferably transparent, it may be formed of a glass plate that is colored in such a way that transparency is not impaired.

The window glass for vehicle may have a curved shape so that when it is attached to the vehicle, the surface thereof on the exterior side of the vehicle is projected. When the window glass for vehicle is a laminated glass, each of the glass plate on the interior side of the vehicle and the glass plate on the exterior side of the vehicle may have a curved shape so that the surface thereof on the exterior side of the vehicle is projected.

When the window glass for vehicle is a laminated glass, a known thermoplastic resin film made of polyvinyl butyral (PVB), ethylene-vinyl acetate copolymer resin (EVA), or the like is used as an intermediate film. The intermediate film may be transparent or colored. Further, the intermediate film may be composed of two or more layers.

Further, when the window glass for vehicle is an organic glass, a transparent resin such as polycarbonate (PC), polymethyl methacrylate (PMMA), or the like may be used as a material of the organic glass.

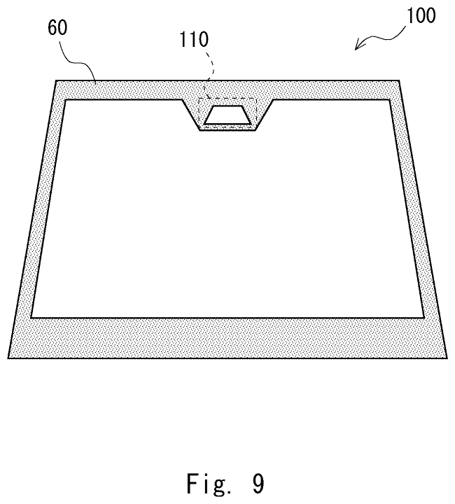

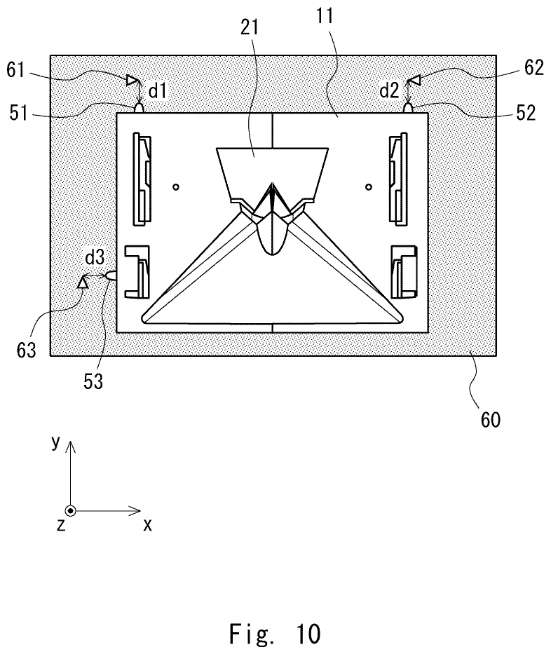

FIG. 9 is a plan view for explaining an example of a configuration of a window glass for vehicle to which the bracket according to this embodiment is attached. FIG. 10 is a plan view for explaining a method for positioning the bracket according to this embodiment in the window glass for vehicle. FIG. 9 shows a windshield as a window glass for vehicle 100. A light-shielding region 60 is formed at a peripheral edge of a windshield 100. FIG. 10 shows an example in which the bracket piece 11 is attached to a region 110 of the window glass for vehicle 100 shown in FIG. 9. As shown in FIG. 10, the light-shielding region 60 is formed at a position in the window glass for vehicle where the bracket piece 11 is provided.

Note that no light-shielding region is preferably provided at a position in the window glass for vehicle corresponding to the hole part 21 of the bracket piece 11. An information acquisition apparatus such as a camera is attached to the bracket piece 11. The hole part 21 is formed at a position corresponding to the lens of the camera or the like, and the information acquisition apparatus acquires information about the outside of the vehicle through the hole part 21. Therefore, no light-shielding region is preferably provided at a position in the window glass for vehicle corresponding to the hole part 21.

The light-shielding region 60 is formed, for example, by applying a ceramic color paste containing a black pigment and a fusible glass frit to the main surface of the window glass for vehicle and then firing it. By providing the light-shielding region 60, the adhesive member or the like applied to the window glass for vehicle can be prevented from deteriorating due to ultraviolet rays. Further, since the bracket piece 11 is hardly visible from the outside of the vehicle, the design can be improved. Note that, although FIG. 10 shows an example in which the light-shielding region 60 is formed at a position corresponding to the bracket piece 11, the light-shielding region is preferably formed over the entire region to which the brackets 1 and 2 (see FIGS. 2 and 4) are bonded.

As shown in FIG. 10, reference points 61 to 63 for positioning the bracket piece 11 are formed in the light-shielding region 60. The reference points 61 to 63 may be formed, for example, by not providing the light-shielding region 60 at a position corresponding to the reference points 61 to 63. Further, projection parts 51 to 53 for positioning are formed in the bracket piece 11. Specifically, in the bracket piece 11, the projection part 51 is formed at a position corresponding to the reference point 61, the projection part 52 is formed at a position corresponding to the reference point 62, and the projection part 53 is formed at a position corresponding to the reference point 63.

Further, by arranging the reference points 61 to 63 formed in the light-shielding region 60 and the projection parts 51 to 53 formed in the bracket piece 11 so that they are spaced apart from each other by a predetermined distance, the bracket piece 11 is positioned on the main surface of the window glass for vehicle. The distance between the reference point and the projection part is preferably 1.5 to 20 mm, more preferably 3.0 to 10 mm, and still more preferably 3.0 to 5.0 mm. Specifically, as shown in FIG. 10, the apex of the triangular reference point 61 on the positive side in the x-axis direction and the tip of the projection part 51 on the positive side in the y-axis direction are located so as to be spaced apart from each other by a distance d1.

Further, the apex of the triangular reference point 62 on the negative side in the x-axis direction and the tip of the projection part 52 on the positive side in the y-axis direction are located so as to be spaced apart from each other by a distance d2. Further, the apex of the triangular reference point 63 on the positive side in the y-axis direction and the tip of the projection part 53 on the negative side in the x-axis direction are located so as to be spaced apart from each other by a distance d3. By this structure, the bracket piece 11 is positioned on the main surface of the window glass for vehicle. Note that the x-axis direction indicates the vehicle width direction, and the y-axis direction indicates the up/down direction of the window glass for vehicle.

For example, by adjusting the distances d1 and d2, the position of the bracket piece 11 in the y-axis direction and the rotation angle thereof on the xy plane can be adjusted. Further, by adjusting the distance d3, the position of the bracket piece 11 in the x-axis direction can be adjusted.

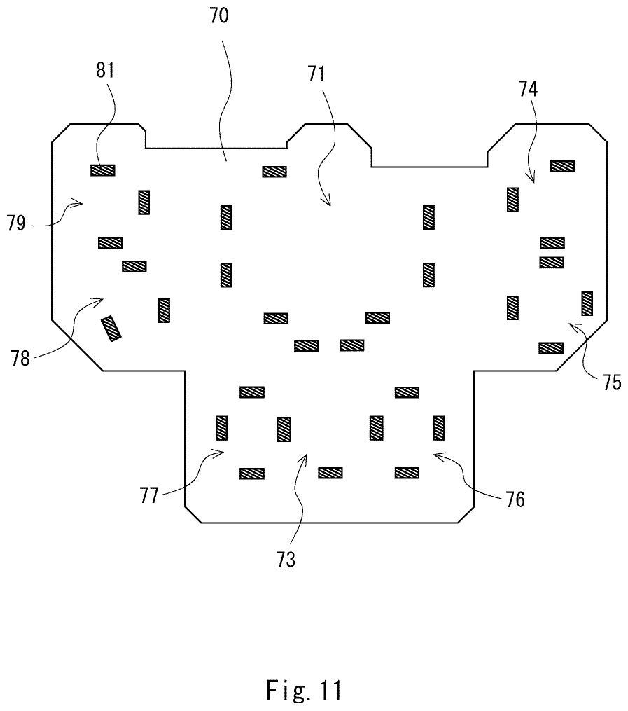

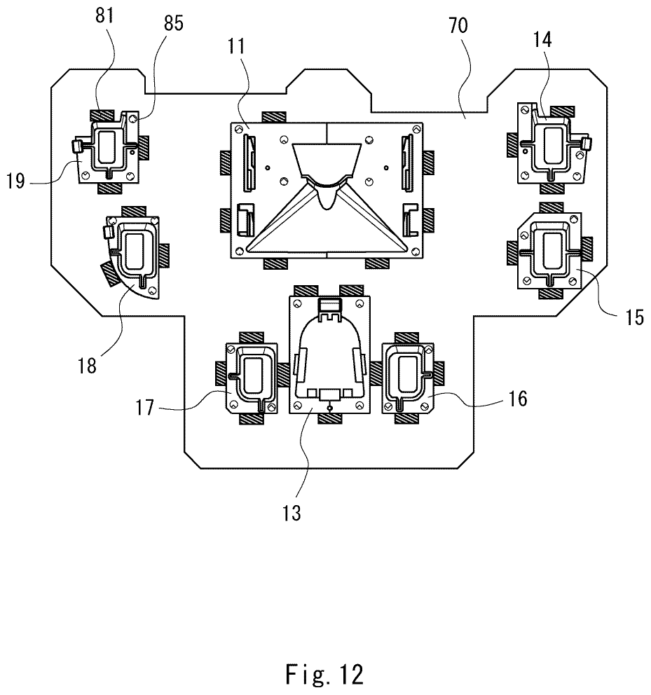

Each of FIGS. 11 and 12 is a plan view for explaining a method for attaching the bracket according to this embodiment to the window glass for vehicle. When the bracket according to this embodiment is attached to the window glass for vehicle, an adapter 70 shown in FIG. 11 is used. FIGS. 11 and 12 describe a case where the bracket 2 shown in FIG. 4 is attached to the window glass for vehicle.

A plurality of holding parts 81 for holding the respective bracket pieces 11 and 13 to 19 are formed in the adapter 70 shown in FIG. 11. The plurality of holding parts 81 are formed on the surface of the flat plate part of the adapter 70. Further, regions 71 and 73 to 79 where the respective bracket pieces 11 and 13 to 19 are disposed are provided in the adapter 70. Before the bracket 2 according to this embodiment is attached to the window glass for vehicle, the bracket pieces 11 and 13 to 19 are respectively disposed in the regions 71 and 73 to 79 of the adapter 70 (see FIG. 12).

As shown in FIG. 12, adhesive members 85 are provided in the surfaces to which the respective bracket pieces 11 and 13 to 19 are bonded. In this embodiment, since the adhesive members 85 are provided in the respective bracket pieces 11 and 13 to 19, a larger number of adhesive members 85 can be provided than that in the case of the bracket 101 according to the related art shown in FIG. 6. Therefore, the bracket can be firmly attached to the window glass for vehicle. Note that, although FIG. 12 shows an example in which the adhesive members 85 are provided in a dotted manner, the adhesive members may be provided in a linear manner. As the areas of the adhesive members 85 increase, the bracket pieces 11 and 13 to 19 can be firmly attached to the window glass for vehicle.

After that, while each of the bracket pieces 11 and 13 to 19 is held by the adapter 70, each of the bracket pieces 11 and 13 to 19 is positioned on the main surface of the window glass for vehicle, and each of the bracket pieces 11 and 13 to 19 is bonded to the main surface of the window glass for vehicle. Note that the method for positioning each of the bracket pieces 11 and 13 to 19 has been described above and the description thereof will thus be omitted.

By using the above-described method, each of the bracket pieces 11 and 13 to 19 can be bonded to the main surface of the window glass for vehicle.

The window glass with a bracket for vehicle according to this embodiment may be used when a new vehicle is produced. Further, when the window glass of a vehicle used by a user is damaged, the window glass with a bracket for vehicle according to this embodiment may be used to repair it. In this case, the cover and the information acquisition apparatus attached to the vehicle used by the user may be reused.

Although the present invention has been described with reference to the above-described embodiments, the present invention is not limited only to the structures of the above-described embodiments. Needless to say, the present invention includes various modifications, corrections, or combinations that can be made by a person skilled in the art within the scope of the claimed invention of the present application.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A window glass with a bracket for vehicle, comprising: a window glass for vehicle; and
a bracket made of a resin for fixing an information acquisition apparatus to the window glass for vehicle, the bracket comprising a plurality of bracket pieces, wherein the plurality of bracket pieces are each disposed so as to be spaced apart from each other on a main surface of the window glass for vehicle.

2. The window glass with a bracket for vehicle according to claim 1, wherein
the information acquisition apparatus comprises a main body and a cover configured to cover the main body, and
the bracket comprises:
an apparatus fixing bracket piece for fixing the main body of the information acquisition apparatus; and
a cover fixing bracket piece for fixing the cover configured to cover the main body of the information acquisition apparatus.

3. The window glass with a bracket for vehicle according to claim 2, wherein the cover fixing bracket piece is disposed around the apparatus fixing bracket piece on the main surface of the window glass for vehicle.

4. The window glass with a bracket for vehicle according to claim 2, wherein the apparatus fixing bracket piece is made of a material having a rigidity higher than that of the cover fixing bracket piece.

5. The window glass with a bracket for vehicle according to claim 4, wherein the apparatus fixing bracket piece is made of a resin containing a glass fiber.

6. The window glass with a bracket for vehicle according to claim 1, wherein a light-shielding region is formed at a position in the window glass for vehicle where the bracket is provided.

7. The window glass with a bracket for vehicle according to claim 6, wherein a reference point for positioning the bracket piece is formed in the light-shielding region, and a projection part for positioning is formed at a position in the bracket piece corresponding to the reference point.

8. The window glass with a bracket for vehicle according to claim 7, wherein the reference point formed in the light-shielding region and the projection part formed in the bracket piece are disposed so as to be spaced apart from each other by a predetermined distance.

9. The window glass with a bracket for vehicle according to claim 1, wherein thicknesses of adhesive members provided between the respective bracket pieces and the window glass for vehicle are different from each other, and an angle at which each of the bracket pieces is attached to the main surface of the window glass for vehicle is greater than 0° and smaller than or equal to 15°.

10. The window glass with a bracket for vehicle according to claim 1, wherein the information acquisition apparatus is at least one of a camera, a millimeter-wave radar, an infrared sensor, a communication device, a raindrop sensor, a temperature and humidity sensor, and a mirror base for a rearview mirror.
